(19) United States
(12) Patent Application Publication
(10) Pub. No.: US 2018/0037701 A1
(43) Pub. Date: Feb. 8, 2018

(54) COPOLYMER COMPRISING AT LEAST THREE BLOCKS: POLYAMIDE BLOCKS, PEG BLOCKS AND OTHER BLOCKS

(71) Applicant: Arkema France, Colombes (FR)

(72) Inventors: Alejandra REYNA-VALENCIA, Aviron (FR); Frederic MALET, Lyon (FR); Quentin PINEAU, Evreux (FR)

(73) Assignee: Arkema France, Colombes (FR)

(21) Appl. No.: 15/537,069

(22) PCT Filed: Dec. 18, 2015
(86) PCT No.: PCT/EP2015/080593

§ 371 Date: Jun. 16, 2017

(30) Foreign Application Priority Data
Dec. 19, 2014 (FR) 1463005

(51) Int. Cl. C08G 81/00; C08K 3/00; C08L 23/06; C08K 5/00; C08G 69/40; C08G 65/333

(52) U.S. Cl. CPC C08G 81/00; C08G 69/40; C08G 65/33327; C08L 23/06; C08K 5/0075; C08K 3/0066; C08L 2201/04; C08L 2205/22; C08L 2207/066; C08K 2201/017

(57) ABSTRACT

The present invention relates to elastomeric thermoplastic polymers (ETP) and especially technical polymers with high added value used in varied sectors, such as electronics, motor vehicles or sport. The present invention more particularly relates to copolymers containing polyether blocks and polyamide blocks, abbreviated as “PEBA”, which have good antistatic properties. Even more particularly, the invention relates to a copolymer containing at least one polyamide (PA) block, at least one polyethylene glycol (PEG) block and at least one block that is more hydrophobic than the PEG block. A subject of the invention is also a process for synthesizing such thermoplastic elastomers which have good antistatic properties and the use thereof in any type of thermoplastic polymer matrix in order to afford this matrix antistatic properties.

The present invention relates to elastomeric thermoplastic polymers (ETP) and especially technical polymers with high added value used in varied sectors, such as electronics, motor vehicles or sport. The present invention more particularly relates to copolymers containing polyether blocks and polyamide blocks, abbreviated as “PEBA”, which have good antistatic properties. Even more particularly, the invention relates to a copolymer containing at least one polyamide (PA) block, at least one polyethylene glycol (PEG) block and at least one block that is more hydrophobic than the PEG block. A subject of the invention is also a process for synthesizing such thermoplastic elastomers which have good antistatic properties and the use thereof in any type of thermoplastic polymer matrix in order to afford this matrix antistatic properties.

The formation and retention of static electricity charges at the surface of most plastics is known. For example, the presence of static electricity on thermoplastic films causes these films to stick together, making them difficult to separate. The presence of static electricity on packaging films may give rise to the accumulation of dusts on the objects to be packaged and thus perturb their use. Static electricity can also damage microprocessors or constituents of electronic circuits. Static electricity can also cause the combustion or explosion of flammable materials, for instance expandable polystyrene beads containing pentane.

Antistatic agents, such as ionic surfactants like ethoxylated amines or sulfonates, are known as additives for polymer matrices. However, the antistatic properties of polymers incorporating these surfactants depend on the ambient humidity and they are therefore not permanent. The reason for this is that these surfactants have a tendency to migrate to the surface of the polymers and then to be lost.

Hydrophilic copolymers containing polyamide blocks and polyether blocks are also used as antistatic agents, which, for their part, have the advantage of not migrating. The antistatic properties are permanent and independent of the ambient humidity. JP 60 023 435 A, EP 242 158, WO 2001/010 951, EP 1 046 675 and EP 829 520 are especially known, which describe polymeric substrates that are rendered antistatic by addition of a copolymer containing polyether blocks and polyamide blocks.

In the last decade, ETPs such as the materials sold by Groupe Arkema under the brand name Pebax®, have gradually established themselves in the field of electronic components, by virtue of their mechanical properties, and especially their exceptional elastic recovery property. The term “ETP” means a copolymer containing blocks comprising, in alternation, “hard” or “rigid” blocks or segments (with relatively thermoplastic behavior) and “supple” or “flexible” blocks or segments (with relatively elastomeric behavior).

For applications of this type, the parts must be able to withstand both high pressure and high temperature so as not to run the risk of being damaged, deteriorated or deformed, or of incurring modified mechanical properties. The grades of the Pebax® brand have good antistatic properties and are endowed with excellent mechanical properties. However, when they are used as antistatic additives in a thermoplastic polymer matrix, said matrix has a surface of mediocre quality.

The aim of the present invention is to provide a copolymer which improves the antistatic properties of polymer matrices incorporating same and which does not have the drawbacks of the prior art.

One subject of the present invention is thus a copolymer comprising:
from 5 to 50% by weight, relative to the total weight of the copolymer, of at least one polyamide (PA) block,
from 20 to 94% by weight, relative to the total weight of the copolymer, of at least one polyethylene glycol (PEG) block,
from 1 to 45% by weight, relative to the total weight of the copolymer, of at least one block that is more hydrophobic than the polyethylene glycol (PEG) block, said block that is more hydrophobic than the PEG block being chosen from a polyether (PE) block other than PEG, a polyester (PES) block and a polyolefin (PO) block.

The present invention also relates to a process for synthesizing the copolymer, and also to the uses thereof.

Finally, a subject of the present invention is a composition comprising such a copolymer.

Other advantages and characteristics of the invention will emerge more clearly on examining the detailed description and the attached drawings, in which:

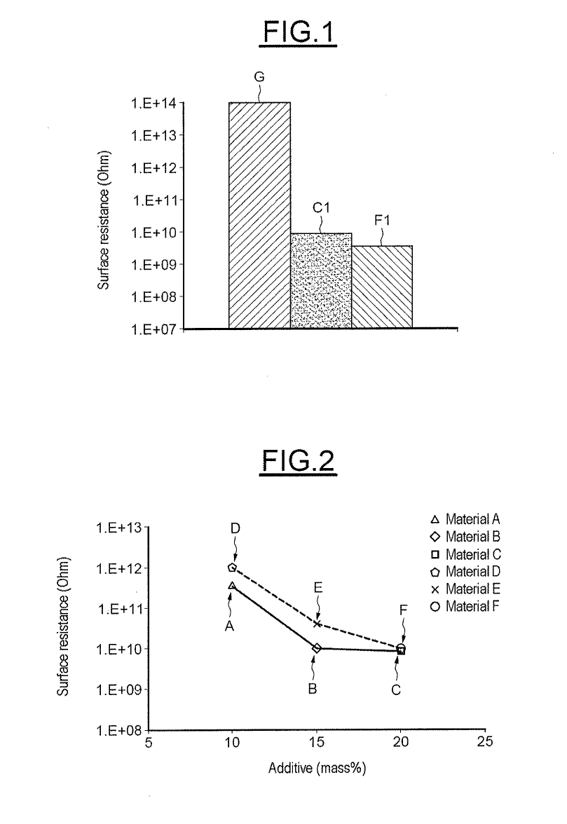

FIG. 1 is a histogram comprising the surface resistances of various materials obtained via an injection process;

FIG. 2 is a graph comparing the surface resistances of various materials, comprising copolymers incorporated into a polyolefin matrix at various mass contents, obtained via an extrusion process;

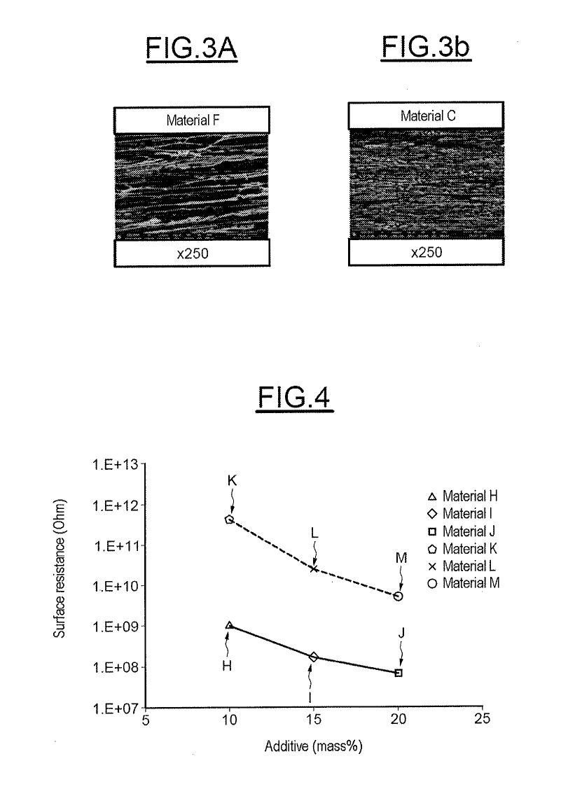

FIG. 3 shows two SEM images representing the surface of two materials;

FIG. 4 is a graph comparing the surface resistances of different materials comprising copolymers, doped with an ionic liquid, incorporated into a polyolefin matrix at various mass contents.

The nomenclature used for defining polyamides is described in standard ISO 1874-1: 1992 “Plastics-Polyamide (PA) molding and extrusion materials-Part 1: Designation system”, especially on page 3 (tables 1 and 2) and is well known to those skilled in the art.

It is moreover pointed out that the expressions “between . . . and . . . ” and “from . . . to . . . ” used in the present description should be understood as including each of the mentioned limits.

For the purposes of the present invention, the term “block” means a polymeric segment of the same chemical nature, namely, for example, polyamide or polyether. This polymeric block is formed from a homopolymer, i.e. formed from the repetition of the same unit.

One subject of the present invention is thus a copolymer comprising:
from 5 to 50% by weight, relative to the total weight of the copolymer of at least one polyamide block (denoted as PA),
from 20 to 94% by weight, relative to the total weight of the copolymer of at least one polyethylene glycol block (denoted as PEG),
from 1 to 45% by weight, relative to the total weight of the copolymer, of at least one block that is more hydrophobic than the polyethylene glycol (PEG) block, said block that is more hydrophobic than the PEG block being chosen from a polyether (PE) block other than PEG, a polyester (PES) block and a polyolefin (PO) block.

Polyamide Block

Three types of PA blocks may advantageously be used. The PA block(s) contained in the copolymer according to the invention may be chosen from:
a block obtained by the polycondensation of amino acid units;
a block obtained by the polycondensation of lactam units;
a block obtained by the polycondensation of units corresponding to the formula (Ca diamine).(Cb diamine).

The amino acid units that may constitute a PA block are chosen from 9-aminononanoic acid, 10-aminodecanoic acid, 10-aminoundecanoic acid, 12-aminododecanoic acid and 11-aminoundecanoic acid, and also derivatives thereof, especially N-heptyl-11-aminoundecanoic acid.

The lactam units that may constitute a PA block are chosen from pyrrolidinone, 2-piperidinone, enantholactam, caprylolactam, pelargolactam, decanolactam, undecanolactam and lauryllactam.

As regards the units corresponding to the formula (Ca diamine).(Cb diamine) which may constitute a PA block, the unit (Ca diamine) is chosen from linear or branched aliphatic diamines, cycloaliphatic diamines and alkylaromatic diamines.

The linear aliphatic (Ca diamine) monomer, of formula H₂N—(CH₂)ₐ—NH₂, is preferentially chosen from butanediamine (a=4), pentanediamine (a=5), hexanediamine (a=6), heptanediamine (a=7), octanediamine (a=8), nonanediamine (a=9), decanediamine (a=10), undecanediamine (a=11), dodecanediamine (a=12), tridecanediamine (a=13), tetradecanediamine (a=14), hexadecanediamine (a=16), octadecanediamine (a=18), octadecenediamine (a=18), eicosanediamine (a=20), docosanediamine (a=22) and diamines obtained from fatty acids.

When the diamine is aliphatic and branched, it may comprise one or more methyl or ethyl substituents on the main chain. For example, the (Ca diamine) monomer may be advantageously chosen from 2,2,4-trimethyl-1,6-hexanediamine, 2,4,4-trimethyl-1,6-hexanediamine, 1,3-diaminopentane, 2-methyl-1,5-pentanediamine and 2-methyl-1,8-octanediamine.

The cycloaliphatic (Ca diamine) monomer is advantageously chosen from bis(3,5-dialkyl-4-aminocyclohexyl)methane, bis(3,5-dialkyl-4-aminocyclohexyl)ethane, bis(3,5-dialkyl-4-aminocyclohexyl)propane, bis(3,5-dialkyl-4-aminocyclohexyl)butane, bis(3-methyl-4-aminocyclohexyl)methane (BMACM or MACM), p-bis(aminocyclohexyl)methane (PACM) and isopropylidenedi(cyclohexylamine) (PACP). It may also comprise the following carbon backbones: norbornylmethane, cyclohexylmethane, dicyclohexylpropane, di(methylcyclohexyl), di(methylcyclohexyl)propane. A nonexhaustive list of these cycloaliphatic diamines is given in the publication “Cycloaliphatic Amines” (Encyclopedia of Chemical Technology, Kirk-Othmer, 4th Edition (1992), pages 386-405).

The alkylaromatic (Ca diamine) monomer is preferentially chosen from 1,3-xylylenediamine and 1,4-xylylenediamine.

The unit (Cb diacid) is chosen from linear or branched aliphatic diacids, cycloaliphatic diacids and aromatic diacids.

The linear aliphatic (Cb diacid) monomer is advantageously chosen from succinic acid (b=4), pentanedioic acid (b=5), adipic acid (b=6), heptanedioic acid (b=7), octanedioic acid (b=8), azelaic acid (b=9), sebacic acid (b=10), undecanedioic acid (b=11), dodecanedioic acid (b=12), brassylic acid (b=13), tetradecanedioic acid (b=14), hexadecanedioic acid (b=16), octadecanedioic acid (b=18), octadecenedioic acid (b=18), eicosanedioic acid (b=20), docosanedioic acid (b=22) and fatty acid dimers containing 36 carbons.

The fatty acid dimers mentioned above are dimerized fatty acids obtained by oligomerization or polymerization of unsaturated monobasic fatty acids bearing a long hydrocarbon-based chain (such as linoleic acid and oleic acid), as described especially in EP 0 471 566.

The cycloaliphatic (Cb diacid) monomer may comprise the following carbon backbones: norbornylmethane, cyclohexylmethane, dicyclohexylpropane, di(methylcyclohexyl), di(methylcyclohexyl)propane.

The aromatic (Cb diacid) monomer is preferentially chosen from terephthalic acid (denoted as T), isophthalic acid (denoted as I) and naphthalenic diacids.

Advantageously, the PA blocks are chosen from PA6, PA11 and PA12 blocks and PA 4.6, PA 4.12, PA 4.14, PA 4.18, PA 6.6, PA 6.10, PA 6.12, PA 6.14, PA 6.18, PA 9.6, PA 9.12, PA 10.10, PA 10.12, PA 10.14 and PA 10.18 blocks.

The number-average molar mass Mn of the PA blocks is between 400 and 20 000 g/mol and preferably between 500 and 10 000 g/mol. The molar mass is determined from the potentiometric assay of the carboxylic acid functions —COOH in the benzyl alcohol with tetra-n-butylammonium hydroxide by means of the following relationship: Mn=2/[COOH], in which Mn is expressed in g/mol and [COOH], expressed in mol/g, represents the amount of material of the carboxylic acid functions per gram of polymer.

80 mL of benzyl alcohol are poured into a container comprising 1 g of polymer. The solution is heated with stirring for 45 minutes at 155° C. or for 90 minutes at 130° C. The solution is then cooled to 80° C. and then titrated with precalibrated tetra-n-butylammonium hydroxide.

Chain Termination

The PA block terminates either with amine functions or with acid functions.

Preferably, the PA block bears acid chain termination. It is then referred to as a diacid PA block.

Advantageously, the PA block bears amine chain termination. It is then referred to as a diamine PA block.

The copolymer according to the invention may comprise several PA blocks of different chemical nature.

According to a particular embodiment of the invention, the PA block is a statistical, alternating or block copolyamide.

The copolymer according to the invention comprises from 5 to 50% by weight, relative to the total weight of the copolymer, preferably from 30 to 47% by weight, relative to the total weight of the copolymer, of the PA block(s).

PEG Block

The polyethylene glycol (PEG) block included in the copolymer according to the invention is a block comprising a molar mass of from 100 to 20 000 g/mol, preferably from 600 to 1500 g/mol. The PEG block is a homopolymer obtained by reacting ethylene glycol units.

The PEG block preferably bears alcohol or amine chain termination.

It is possible to modify the end functions of the PEG block.

The end functions of the PEG block are not modified when the PEG block bears alcohol chain termination.

The end functions of the PEG block are modified when the PEG block bears amine chain termination. Thus, the PEG block bearing amine chain ends may be obtained by cyanoacetylation of the PEG sequences.

The copolymer according to the invention comprises from 20 to 94% by weight, relative to the total weight of the copolymer, preferably from 20 to 60% by weight, more preferably from 20 to 45% by weight, relative to the total weight of the copolymer, of said PEG block.

Hydrophobic Block

The term “block that is more hydrophobic than the PEG block” means a block in which the ratio of the number of carbon atoms to the number of oxygen atoms, in a monomer unit, is greater than or equal to 2.

PE Block

The PE blocks comprise alkylene oxide units. These units may usually be propylene oxide units or tetrahydrofuran (which leads to polytetramethylene glycol chains). Advantageously, said PE block included in the copolymer according to the invention is chosen from polypropylene glycol (PPG), i.e. formed from propylene oxide units, polytetramethylene glycol (PTMG), i.e. formed from tetramethylene glycol units, but also polyhexamethylene ether glycol, polytrimethylene ether glycol (PO₃G), poly(3-alkyl tetrahydrofuran), in particular poly(3-methyltetrahydrofuran (poly(3MeTHF)), and block or statistical copolymers thereof. The copolymer according to the invention may comprise a PE block of copolyether type containing a sequence of at least two PE blocks mentioned above.

It is possible to calculate, by way of example, for the PPG block, the ratio of the number of carbon atoms to the number of oxygen atoms, in the propylene glycol unit, which is 3. Thus, the PPG block is a block that is more hydrophobic than the PEG block for the purposes of the invention.

Use may also be made of blocks obtained by oxyethylation of bisphenols, for instance bisphenol A. The latter products are described in patent EP 613 919.

The polyether blocks may also be formed from ethoxylated primary amines. As examples of ethoxylated primary amines, mention may be made of the products of formula:

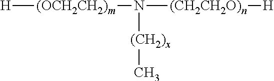

in which m and n are between 1 and 20, and x is between 8 and 18. These products are available commercially under the brand name Noramox® from the company Ceca and under the brand name Genamin® from the company Clariant.

The mass Mn of the polyether blocks is between 100 and 6000 g/mol and preferably between 200 and 3000 g/mol.

Preferably, the PE block bears alcohol or amine chain termination.

The end functions of the PE block are not modified when the PE block bears alcohol chain termination.

The end functions of the PEG block are modified when the PE block bears amine chain termination.

Thus, the polyether (PE) blocks may comprise polyoxyalkylene blocks bearing NH₂ chain ends, such blocks possibly being obtained by cyanoacetylation of aliphatic α-ω dihydroxylated polyoxyalkylene blocks known as polyetherdiols. More particularly, use may be made of the Jeffamine products (for example Jeffamine D400, D2000, ED 2003, XTJ 542, commercial products from the company Huntsman, also described in patents JP2004346274, JP2004352794 and EP1482011).

PES Block

The polyester (PES) blocks that may be used as blocks that are more hydrophobic than the PEG blocks are the polyesters usually manufactured by polycondensation between a dicarboxylic acid and a diol and in which the repeating unit comprises at least nine carbon atoms. The appropriate carboxylic acids comprise those mentioned above used for forming the polyamide blocks, with the exception of aromatic acids, such as terephthalic acid and isophthalic acid. The appropriate diols comprise linear aliphatic diols such as ethylene glycol, 1,3-propylene glycol, 1,4-butylene glycol, 1,6-hexylene glycol, branched diols such as neopentyl glycol, 3-methylpentane glycol, 1,2-propylene glycol, and cyclic diols such as 1,4-bis(hydroxymethyl)cyclohexane and 1,4-cyclohexanedimethanol. An example of a polyester used is the polyadipate family.

It is possible to calculate, by way of example, for the block prepared from heptanedioic acid and ethylene glycol, the ratio of the number of carbon atoms to the number of oxygen atoms, in the repeating unit, namely a unit comprising a diacid unit and a diol unit, which is 2.25. Thus, the block prepared from heptanedioic acid and ethylene glycol is a block that is more hydrophobic than the PEG block for the purposes of the invention.

The term “polyesters” also means poly(caprolactone) and PESs based on fatty acid dimers, in particular the products of the Priplast® range from the company Uniqema.

Preferably, the PES block bears alcohol or acid chain termination.

A PES block of alternating, statistical or block “copolyester” type, containing a sequence of at least two types of PES mentioned above, may also be envisaged.

PO Block

The polyolefin (PO) block that may be used as block that is more hydrophobic than the PEG block is a polymer comprising as monomer an α-olefin, i.e. homopolymers of an olefin or copolymers of at least one α-olefin and of at least one other copolymerizable monomer, the α-olefin advantageously containing from 2 to 30 carbon atoms.

It should be noted that the PO block clearly corresponds to the definition of the block that is more hydrophobic than the PEG block mentioned above, when, in the absence of an oxygen atom, the calculation of the ratio gives an infinite result.

Examples of α-olefins that may be mentioned include ethylene, propylene, 1-butene, 1-pentene, 3-methyl-1-butene, 1-hexene, 4-methyl-1-pentene, 3-methyl-1-pentene, 1-octene, 1-decene, 1-dodecene, 1-tetradecene, 1-hexadecene, 1-octadecene, 1-eicocene, 1-dococene, 1-tetracocene, 1-hexacocene, 1-octacocene and 1-triacontene. These α-olefins may be used alone or as a mixture of two or more than two.

Examples that may be mentioned include:
ethylene homopolymers and copolymers, in particular low-density polyethylene (LDPE), high-density polyethylene (HDPE), linear low-density polyethylene (LLDPE), very-low-density polyethylene (VLDPE), and polyethylene obtained by metallocene catalysis,
propylene homopolymers and copolymers,
essentially amorphous or atactic poly-α-olefins (APAO),
ethylene/α-olefin copolymers such as ethylene/propylene, EPR elastomers (ethylene-propylene-rubber), and EPDM (ethylene-propylene-diene), and mixtures of polyethylene with an EPR or an EPDM,
styrene/ethylene-butene/styrene (SEBS), styrene/butadiene/styrene (SBS), styrene/isoprene/styrene (SIS) and styrene/ethylene-propylene/styrene (SEPS) block copolymers,
copolymers of ethylene with at least one product chosen from salts or esters of unsaturated carboxylic acids such as alkyl (meth)acrylates, the alkyl possibly containing up to 24 carbon atoms, vinyl esters of saturated carboxylic acids, for instance vinyl acetate or vinyl propionate, and dienes, for instance 1,4-hexadiene polybutadiene.

It may thus be envisaged for the repeating unit of the PO block to contain one or more oxygen atoms. Needless to say, if such is the case, the PO block must correspond to the definition of the block that is more hydrophobic than the PEG block for the purposes of the present invention, i.e. the monomer unit of said PO block has a ratio of the number of carbon atoms to the number of oxygen atoms of greater than 2.

Advantageously, the PO block that may be used as block that is more hydrophobic than the PEG block is a polyolefin block functionalized either with a maleic anhydride function or with an epoxy function.

According to an advantageous embodiment of the invention, said polyolefin block comprises hydrogenated or non-hydrogenated polyisobutylene and/or polybutadiene.

Preferably, the block that is more hydrophobic than the PEG block is the PTMG block.

Preferably, the PA block is the PA6, PA11 or PA12 block.

Advantageously, the PES block is a polyadipate block.

The copolymer according to the invention comprises from 1 to 45% by weight, relative to the total weight of the copolymer, preferably from 15 to 35% by weight, relative to the total weight of the copolymer, of at least one block that is more hydrophobic than the PEG block.

Copolymer Arrangement

Generally, the polyamide block is linked to a block that is more hydrophobic than the PEG block and to a PEG block. The copolymer arrangement is such that the PA block is in a central position in the sequence of blocks. However, this arrangement is not the only one that may be envisaged. Specifically, the terminal acid functions of the polyester block may react, for example, with the terminal amine functions of the PEG block (or with the terminal acid functions of the PEG block), on the one hand, and with the amine functions of the PA block, on the other hand. The copolymer arrangement is then PA-PES-PEG.

The copolymer according to the invention comprises at least one polyamide block bearing acid chain termination or bearing amine chain termination.

Acid Functions of the PA Block

The terminal acid functions of the polyamide block may react:
with the terminal alcohol or amine functions of the other two blocks, i.e. of the PEG block and of the PE block,
with the alcohol functions of the PES block
with the epoxy functions of the PO block.

Thus, the bond between the polyamide block and the polyether block(s) is an ester or amide bond. The bond between the PA block and the PES block(s) and/or the PO block(s) is an ester or bond.

As a result, there will be, for example:
a PE-PA-PEG sequence, the alcohol end groups of the polyether blocks not being able to react together,
a PES-PA-PEG sequence, the alcohol end functions of the polyester blocks not being able to react together, or
a PO-PA-PEG sequence, the epoxy end functions of the polyolefin blocks not being able to react together.

Amine Functions of the PA Block

The amine end functions of the polyamide can react with the acid functions of the PES block(s) or with the maleic anhydride functions of the PO block(s).

Thus, the bond between the polyamide block and the PES block(s) is an amide bond. The bond between the polyamide block and the polyolefin block(s) is also an amide bond.

Advantageously, the copolymer according to the invention has the following structure: PEG-PA6-PTMG, PEG-PA11-PTMG, PEG-PA12-PTMG, PEG-PA10.10-PTMG, PEG-PA10.12-PTMG and mixtures thereof, and preferably comprises PEG-PA12-PTMG.

The copolymer according to the invention may comprise only three blocks, namely a PA block, a PEG block and a block that is more hydrophobic than PEG as defined above. However, the copolymer may comprise four, five or even more identical or different blocks chosen from the abovementioned blocks.

Advantageously, the blocks may be derived from renewable materials and/or from materials of fossil origin. Advantageously, said blocks are at least partly derived from renewable materials. According to a particularly advantageous mode of the present invention, the polyamide blocks and/or the polyether blocks and/or the polyester blocks and/or the polyolefin blocks are entirely derived from renewable materials.

Process

A subject of the present invention is also a process for synthesizing the copolymer in accordance with the invention, comprising the following steps:
mixing and reacting at least one PA block with at least one PEG block and at least one block that is more hydrophobic than the PEG block,
recovering said copolymer.

In a preferred embodiment, the process according to the invention comprises the following steps:
introducing into a reactor a mixture comprising at least one PA block, at least one PEG block and at least one block that is more hydrophobic than the PEG block,
heating to a nominal temperature within the range from 180 to 340° C., preferably from 200 to 300° C., preferably from 220 to 270° C.,
stirring and flushing with inert gas,
placing under vacuum at a pressure below 100 mbar, preferably below 50 mbar, preferably below 10 mbar,
adding a catalyst,
stopping when a torque at least equal to 5 N·cm, preferably at least equal to 10 N·cm, preferably at least equal to 20 N·cm, is reached.

Composition

The invention also relates to a composition comprising a copolymer according to the invention.

Advantageously, the composition comprising the copolymer according to the invention, by virtue of the permanent antistatic properties thereof, namely a superficial (or surface) resistivity of less than 10¹² ohm/squared, does not require and therefore does not contain any organic salt.

Nevertheless, it is possible to incorporate an organic salt or an ionic liquid into the composition according to the invention, to further improve its antistatic performance qualities.

Advantageously, the composition according to the invention also comprises from 0.1 to 10%, preferably from 0.1 to 5% by weight of at least one molten organic salt relative to the total weight of the composition.

Organic salts are salts formed from organic cations combined with inorganic or organic anions.

The organic salt is added in molten form, i.e. when the organic salt is at a temperature above its melting point. Preferably, said organic salt has a melting point of less than 300° C., preferably less than 200° C., preferably less than 100° C. and then advantageously constitutes an ionic liquid, preferably less than 30° C. The main properties of ionic liquids are in particular those of being nonvolatile (no diffusion into the atmosphere of volatile organic compounds), non-flammable (and thus easy to handle and to store), stable at high temperature (up to 400° C. for some of them), very good conductors, and very stable with respect to water and oxygen.

Advantageously, the organic salt comprises at least one cation chosen from ammonium, sulfonium, pyridinium, pyrrolidinium, imidazolium, imidazolinium, phosphonium, lithium, guanidinium, piperidinium, thiazolium, triazolium, oxazolium and pyrazolium, and mixtures thereof.

Preferably, the organic salt comprises at least one anion chosen from imides, especially bis(trifluoromethanesulfonyl)imide (abbreviated as NT_{f2}⁻), borates, especially tetrafluoroborate (abbreviated as BF₄⁻), phosphates, especially hexafluorophosphate (abbreviated as PF₆⁻), phosphinates and phosphonates, especially alkyl-phosphonates, amides, especially dicyanamide (abbreviated as DCA⁻), aluminates, especially tetrachloroaluminate (AlCl₄⁻), halides (such as bromide, chloride, iodide, etc. anions), cyanates, acetates (CH₃COO⁻), especially trifluoroacetate, sulfonates, especially methanesulfonate (CH₃SO₃⁻), trifluoromethanesulfonate, sulfates, especially ethyl sulfate, hydrogen sulfate, and mixtures thereof.

For the purposes of the invention, the term “organic salt” more particularly means any organic salt that is stable at the temperatures used during the synthesis of the block copolymer according to the invention. A person skilled in the art can refer to the technical sheets for organic salts, which indicate the limit decomposition temperature of each organic salt.

As examples of organic salts that may be used in the synthetic process according to the invention, mention may be made especially of organic salts based on ammonium cation, based on imidazolium cation or imidazolinium cation, based on pyridinium cation, based on dihydropyridinium cation, based on tetrahydropyridinium cation, based on pyrrolidinium cation, based on guanidine cation or based on phosphonium cation.

The organic salts based on ammonium cation combine, for example:
an N-trimethyl-N-propylammonium cation with a bis(trifluoromethanesulfonyl)imide anion
an N-trimethyl-N-butylammonium or N-trimethyl-N-hexylammonium cation with an anion chosen from bromide, tetrafluoroborate, hexafluorophosphate and bis(trifluoromethanesulfonyl)imide
an N-tributyl-N-methylammonium cation with an iodide, bis(trifluoromethanesulfonyl)imide or dicyanamide anion
a tetraethylammonium cation with a tetrafluoroborate anion
a (2-hydroxyethyl)trimethylammonium cation with a dimethylphosphate anion
a bis(2-hydroxyethyl)ammonium cation with a trifluoracetate anion
a N,N-bis(2-methoxy)ethylammonium cation with a sulfamate anion
an N,N-dimethyl(2-hydroxyethyl)ammonium cation with a 2-hydroxyacetate or trifluoracetate anion
an N-ethyl-N,N-dimethyl-2-methoxyethylammonium cation with a bis(trifluoromethylsulfonyl)imide anion an ethyldimethylpropylammonium cation and a bis(trifluoromethylsulfonyl)imide anion
a methyltrioctylammonium cation and a bis(trifluormethylsulfonyl)imide anion
a methyltrioctylammonium cation and a trifluoroacetate or trifluoromethylsulfonate anion
a tetrabutylammonium cation and a bis(trifluoromethylsulfonyl)imide anion
a tetramethylammonium cation and a bis(oxalato(2-))-borate or tris(pentafluoroethyl)trifluorophosphate anion

Mention may also be made of organic salts based on imidazole, such as disubstituted imidazoles, monosubstituted imidazoles or trisubstituted imidazoles, in particular those based on an imidazolium cation or an imidazolinium cation.

Mention may be made of organic salts based on an imidazolium cation combining, for example:
an H-methylimidazolium cation with a chloride anion
a 1-ethyl-3-methylimidazolium cation with a chloride, bromide, tetrafluoroborate, hexafluorophosphate, trifluoromethanesulfonate, bis(trifluoromethanesulfonyl)imide, tetrachloroaluminate, ethylphosphonate or methylphosphonate, methanesulfonate, ethyl sulfate or ethylsulfonate anion,
a 1-butyl-3-methylimidazolium cation with a chloride, bromide, tetrafluoroborate, hexafluorophosphate, trifluoromethanesulfonate, bis(trifluoromethanesulfonyl)imide, tetrachloroaluminate, acetate, hydrogen sulfate, trifluoroacetate or methanesulfonate anion,
a 1,3-dimethylimidazolium cation with a methylphosphonate anion a 1-propyl-2,3-dimethylimidazolium cation with a bis(trifluoromethanesulfonyl)imide anion
a 1-butyl-2,3-dimethylimidazolium cation with a tetrafluoroborate or bis(trifluoromethanesulfonyl)imide anion
a 1-hexyl-3-methylimidazolium cation with a tetrafluoroborate, hexafluorophosphate or bis(trifluoromethanesulfonyl)imide anion
a 1-octyl-3-methylimidazolium cation with a bis(trifluoromethanesulfonyl)imide anion
a 1-ethanol-3-methylimidazolium cation with a chloride, bromide, tetrafluoroborate, hexafluorophosphate, bis(trifluoromethanesulfonyl)imide or dicyanamide anion.

Examples that may also be mentioned include organic salts based on a pyridinium cation, such as: N-butyl-3-methylpyridinium bromide, N-butylmethyl-4-pyridinium chloride, N-butylmethyl-4-pyridinium tetrafluoroborate, N-butyl-3-methylpyridinium chloride, N-butyl-3-methylpyridinium dicyanamide, N-butyl-3-methylpyridinium methyl sulfate, 1-butyl-3-methylpyridinium tetrafluoroborate, N-butylpyridinium chloride, N-butylpyridinium tetrafluoroborate, N-butylpyridinium trifluoromethylsulfonate, 1-ethyl-3-hydroxymethylpyridinium ethyl sulfate, N-hexylpyridinium bis(trifluoromethylsulfonyl)imide, N-hexylpyridinium trifluoromethansulfonate, N-(3-hydroxypropyl)pyridinium bis(trifluoromethylsulfonyl)imide, N-butyl-3-methylpyridinium trifluoromethanesulfonate, N-butyl-3-methylpyridinium hexafluorophosphate.

Examples that may also be mentioned include organic salts based on a pyrrolidinium cation, such as: butyl-1-methyl-1-pyrrolidinium chloride, butyl-1-methylpyrrolidinium dicyanamide, butyl-1-methyl-1-pyrrolidinium trifluoromethanesulfonate, butyl-1-methyl-1-pyrrolidinium tris(pentafluoroethyl), 1-butyl-1-methylpyrrolidinium bis [oxalato(2-)]borate, 1-butyl-1-methylpyrrolidinium bis(trifluoromethyl sulfonyl)imide, 1-butyl-1-methylpyrrolidinium dicyanamide, 1-butyl-1-methylpyrrolidinium trifluoroacetate, 1-butyl-1-methylpyrrolidinium trifluoromethanesulfonate, butyl-1-methyl-1-pyrrolidinium tris(pentafluoroethyl)trifluorophosphate, 1,1-dimethylpyrrolidinium iodide, 1-(2-ethoxyethyl)-1-methylpyrrolidinium bis(trifluoromethylsulfonyl)imide, 1-hexyl-1 methylpyrrolidinium bis(trifluoromethylsulfonyl)imide, 1-(2-methoxyethyl)-1-methylpyrrolidinium bis(trifluoromethylsulfonyl)imide, methyl-1-octyl-1-pyrrolidinium chloride, 1-butyl-1-methylpyrrolidinium bromide.

Mention may also be made of organic salts combining:
a 1-ethyl-1-methylpyrrolidinium cation with a bromide, tetrafluoroborate, hexafluorophosphate or trifluoromethanesulfonate anion
a 1-butyl-1-methylpyrrolidinium cation with a chloride, bromide, tetrafluoroborate, hexafluorophosphate, trifluoromethanesulfonate, bis(trifluoromethanesulfonyl)imide, dicyanamide, acetate or hydrogen sulfate anion
an N-propyl-N-methylpyrrolidinium cation with a bis(trifluoromethanesulfonyl)imide anion
a 1-methyl-1-propylpiperidinium cation with a bis(trifluoromethanesulfonyl)imide anion

Examples that may also be mentioned include organic salts based on a guanidine cation, such as: guanidine trifluoromethylsulfonate, guanidine tris(pentafluoroethyl)trifluorophosphate, hexamethylguanidine tris(pentafluoroethyl)trifluorophosphate.

Mention may be made of organic salts based on a phosphonium cation, such as trihexyl(tetradecyl)phosphonium bis [oxalate(2-)]borate, trihexyl(tetradecyl)phosphonium bis(trifluoromethylsulfonyl)imide or trihexyl(tetradecyl)phosphonium tris(pentafluoroethyl)trifluorophosphate.

The abovementioned list of organic salts and of cations and anions that may be included in the composition according to the invention is given purely as an illustration, and is not exhaustive or limiting. Consequently, the addition of any organic salt may, needless to say, be envisaged in the composition of the invention, provided that the decomposition temperature of the organic salt is higher than the temperature is of the steps of the process for preparing the composition according to the invention during which the organic salt is present.

In one embodiment, the composition according to the invention also comprises at least one inorganic salt, i.e. an alkali metal salt or alkaline-earth metal salt, among which mention may be made especially of salts of alkali metals such as lithium, sodium, potassium, etc. and salts of alkaline-earth metals such as magnesium, calcium, etc. with organic acids (mono- or dicarboxylic acids containing 1 to 12 carbon atoms, for example formic acid, acetic acid, propionic acid, oxalic acid, succinic acid, etc., sulfonic acids containing 1 to 20 carbon atoms, for example methanesulfonic acid, p-toluenesulfonic acid, thiocyanic acid, etc.) or mineral acids (hydrohalic acids, for example hydrochloric acid or hydrobromic acid, perchloric acid, sulfuric acid, phosphoric acid, etc.). Mention may be made of potassium or lithium acetate, lithium acetate or chloride, magnesium or calcium chloride, sodium chloride or bromide, potassium or magnesium bromide, lithium bromide perchlorate, sodium or potassium perchlorate, potassium sulfate, potassium phosphate, thiocyanate, and analogs thereof.

Among these, the preferred ones are halides, preferably lithium chloride, sodium chloride, potassium chloride, potassium acetates and potassium perchlorates. The amount of inorganic salt is generally within the range from 0.001 to 3%, preferably 0.01 to 2%, relative to the total weight of the composition.

The composition according to the invention may also comprise at least one agent for improving the surface conductivity, chosen from: hygroscopic agents, fatty acids, lubricants, metals, metal films, metal powders, metallic nanopowders, aluminosilicates, amines, such as quaternary amines, esters, fibers, carbon fibers, carbon nanotubes, intrinsically conductive polymers, such as polyaniline, polythiophene or polypyrrole derivatives, and mixtures thereof.

The composition according to the invention may also comprise at least one additive and/or adjuvant chosen from organic or inorganic fillers, reinforcers, plasticizers, stabilizers, antioxidants, UV stabilizers, flame retardants, carbon black, mineral or organic dyes, pigments, dyes, mold-release agents, foaming agents, impact modifiers, shrink-resistance agents, fire retardants, nucleating agents, and mixtures thereof.

Thus, the composition according to the invention may be a mixture of antistatic agents comprising the copolymer according to the invention.

A subject of the present invention is also the use of such a copolymer according to the invention or of such a composition, as an antistatic additive, for improving the antistatic properties of a polymer matrix to which it is added.

A subject of the present invention is also a composition comprising the polymer matrix and the copolymer according to the invention.

Advantageously, said polymer matrix comprises at least one homopolymeric or copolymeric thermoplastic polymer, chosen from: polyolefins, polyamides, fluoro polymers, saturated polyesters, polycarbonate, styrene resins, PMMA, thermoplastic polyurethanes (TPU), copolymers of ethylene and of vinyl acetate (EVA), copolymers bearing polyamide blocks and polyether blocks, copolymers bearing polyester blocks and polyether blocks, copolymers bearing polyamide blocks, polyether blocks and polyester blocks, copolymers of ethylene and of an alkyl (meth)acrylate, copolymers of ethylene with vinyl alcohol (EVOH), ABS, SAN, ASA, polyacetal, polyketones, and mixtures thereof. Mention may be made especially of PC/ABS and PC/ASA resins.

The term “thermoplastic polymer matrix” means any thermoplastic polymer material capable of incorporating a copolymer according to the invention. Thermoplastic polymers are well known to those skilled in the art and especially comprise polyolefins (polyethylene, polypropylene, etc.), poly vinyl chloride, polyethylene terephthalate, polystyrene, polyamides and acrylics.

A subject of the present invention is also the use of the composition comprising the polymer matrix and the composition comprising the copolymer in accordance with the invention for the manufacture of at least some of the following objects: industrial part, motor vehicle part, safety accessory, sign, cornice lighting, information and advertizing panel, display case, engraving, furnishing, shopfitting, decoration, contact ball, dental prosthesis, ophthalmological implant, blood dialysis membrane, optical fibers, art object, decoration, sculpture, lenses, especially photographic camera lenses, disposable photographic camera lenses, printing support, especially a support for direct printing with UV inks for photographic picture, glazing, sunroof, vehicle headlamps, etc.

The examples that follow illustrate the present invention without limiting its scope.

### EXAMPLES

1) Manufacture of the Copolymers

a) Synthesis of the Prepolymers

Water, lactam 12 and adipic acid are introduced into a 14 L autoclave and then placed under an inert atmosphere of nitrogen. The reaction medium is stirred and heated at 290° C. for 3 hours. The autogenous pressure generated is about 30 bar. The reactor is then depressurized to atmospheric pressure and then flushed with nitrogen for 1 hour. The prepolymer thus obtained is discharged into water and then dried at 80° C. under vacuum for 12 hours.

Three prepolymers, PA12(600), PA12(1000) and PA12(1500), respectively, having a number-average molar mass (Mn) of 600, 1000 and 1500 g/mol, respectively, are thus prepared. These prepolymers are homopolyamides bearing acid chain termination. The compounds used for the synthesis, and the weights thereof, are indicated in table 1 below:

TABLE 1

| Prepolymer | PA12(600) | PA12(1000) | PA12(1500) |
|---|---|---|---|
| Water (g) | 500 | 500 | 500 |
| Lactam 12 (g) | 3782 | 4269.3 | 4512.9 |
| Adipic acid (g) | 1718 | 730.7 | 487.1 |

b) Formulation of the Copolymers

The compositions of the copolymers according to the invention (Copo1, Copo2 and Copo3) and of the comparative copolymer (Copo4) are given in Table 2 below. The values are expressed as mass percentages by weight.

TABLE 2

| Copo | 1 (inv) | 2 (inv) | 3 (inv) | 4 (comp) |
|---|---|---|---|---|
| PA12(600) (%) | — | 44 | 33.4 | — |
| PA12(1000) (%) | 45.3 | — | — | — |
| PA12(1500) (%) | — | — | — | 50 |
| PEG(600)⁽¹⁾ (%) | — | 21 | — | — |
| PEG(1500)⁽²⁾ (%) | 32.8 | — | 40 | 50 |
| PTMG(1000)⁽³⁾ (%) | 21.9 | 35 | 26.6 | — |

⁽¹⁾PEG(600): polyethylene glycol bearing alcohol chain termination, having a molar mass (Mn) of 600 g/mol.
⁽²⁾PEG(1500): polyethylene glycol bearing alcohol chain termination, having a molar mass (Mn) of 1500 g/mol.
⁽³⁾PTMG(1000): PTMG homopolymer bearing alcohol chain termination, having a molar mass (Mn) of 1000 g/mol.

Thus, each of the three copolymers according to the invention (Copo1, Copo2 and Copo3) comprises three blocks, a PA block, a PEG block and a PTMG block.

Copo1 comprises 113.4 g of PA, 82 g of PEG and 21.9 g of PTMG.

Copo2 comprises 109.8 g of PA, 52.6 g of PEG and 87.6 g of PTMG.

Copo3 comprises 83.5 g of PA, 99.9 g of PEG and 66.6 g of PTMG.

c) Synthesis of the Copolymers

The three blocks are placed in a glass reactor and a heating phase is started with a nominal temperature of 250° C. Once the medium has melted, the mixture is stirred and a first phase of flushing with nitrogen is performed for one hour. The system is then placed under vacuum (<10 mbar), followed by introducing the catalyst (0.3% by weight of Zr(OBu)₄). The rise in torque is monitored and the test is stopped when a torque of 20 N·cm at 60 rpm is reached.

After grinding said products, rods are produced by extrusion on a μdSM machine.

The rods were tested. The resistivity was evaluated.

The antistatic property of a polymer is mainly characterized by its surface resistivity, which is expressed in ohms/squared and measured according to standard ASTM D257.

2) Evaluation of the Copolymers and Results

a) Measurement of the Surface Resistance

The tests were performed on an M1500P Megohmmeter equipped with electrodes, under the following conditions:
potential difference: 40 V
distance between electrodes: 10 mm
charge time before reading: 20 s
conditioning: 2 weeks in an air-conditioned room

The results are given in Table 3 below:

TABLE 3

| | Surface resistance |
|---|---|
| Copolymer | (Ohm) |
| Copo1 (invention) | 2 × 10⁹ |
| Copo2 (invention) | 5 × 10⁹ |
| Copo3 (invention) | 1 × 10⁹ |
| Copo4 (comparative) | 1 × 10⁹ |

These results indicate that the surface resistance of comparative copo4 is similar to those for the copolymers according to the invention, despite the fact that they contain a smaller mass content of PEG block.

The copolymer according to the invention thus represents an alternative with high added value in terms of mechanical properties and cost.

b) Use of Copolymers in a Thermoplastic Matrix

i) FIGS. 1 and 2

Copo3 is incorporated, at varied mass contents, into an LDPE (low-density polyethylene) polyolefin matrix, grade 1022 FN 24, and materials are obtained.

Copo4 is incorporated, at varied mass contents, into the LDPE (low-density polyethylene) polyolefin matrix, grade 1022 FN 24, and materials are obtained.

When the materials are obtained via an injection process, the material is in the form of a plate. When the materials are obtained via an extrusion process, the material is in the form of a film.

The composition of the various materials is given in table 4 below. The values are expressed as mass percentages:

TABLE 4

| Material | A | B | C | D | E | F | G |
|---|---|---|---|---|---|---|---|
| LDPE (%) | 90 | 85 | 80 | 90 | 85 | 80 | 100 |
| Copo3 (%) | 10 | 15 | 20 | — | — | — | — |
| Copo4 (%) | — | — | — | 10 | 15 | 20 | — |

Material A is a material in which the mass content of copo3 is 10% relative to the weight of material A.

Material B is a material in which the mass content of copo3 is 15% relative to the weight of material B.

Material C is a material in which the mass content of copo3 is 20% relative to the weight of material C.

Material D is a material in which the mass content of copo4 is 10% relative to the weight of material D.

Material E is a material in which the mass content of copo4 is 15% relative to the weight of material E.

Material F is a material in which the mass content of copo4 is 20% relative to the weight of material F.

These materials A to F are materials in the form of a film.

The LDPE polyolefin matrix alone represents material G in the form of a plate.

It should also be pointed out that material C1 has the same composition as material C, but it is in the form of a plate.

Similarly, material F1 has the same composition as material F, but it is in the form of a plate

It should be noted that copo3 and copo4 are called additives when they are incorporated into the polyolefin matrix.

FIG. 1 is a histogram comparing the surface resistance of materials C1, F1 and G obtained via an injection process.

FIG. 1 shows that the surface resistance of materials C1 and F1 is markedly less than that of material G. Moreover, it is also observed that the surface resistance of material C1 is less than that of material F1.

FIG. 2 is a graph comparing the surface resistance of materials A to F obtained via an extrusion process.

It is observed that the surface resistance of material C is less than that of material F.

Moreover, it is observed that, for the same mass content of additive, the surface resistance of the material comprising Copo3 is markedly less than that for the material comprising Copo4.

Thus, the results indicate that the copolymer according to the invention makes it possible to improve the antistatic properties of the polymer matrix incorporating same.

This observation is valid for low mass contents of additives (between 10 and 20% by weight). This represents an advantage since a low content of additive in a polymer matrix has only a small impact on the mechanical properties of said matrix.

ii) FIG. 3

FIG. 3 represents two SEM (scanning electron microscopy) images of the surface of materials C (FIG. 3B) and F (FIG. 3A).

On these images, marking with phosphotungstic acid was performed. The additive appears as white and the matrix as black.

Different morphologies are observed concerning the two materials. Specifically, FIG. 3B shows that the network formed by Copo3 in the polyolefin matrix is finer than the network formed by Copo4 in the polyolefin matrix as shown by FIG. 3A.

Better connectivity of the additive network in the case of the copolymer according to the invention is assumed on account of the modification of the interface tension in the polyolefin matrix. Specifically, the surface of material C appears to be of better quality than that of material F.

iii) FIG. 4

Copo3 and 1.5% by weight of an ionic liquid (IL1), 1-ethyl-3-methylimidazolium bis(trifluoromethanesulfonyl)imide, relative to the total weight of copo3 and of the ionic liquid, are incorporated into the LDPE polyolefin matrix at varied mass contents. Materials in film form are obtained.

The ionic liquid is introduced into copo3 during the step of baking said copo3 in a mixer which is rotated under vacuum at 60° C. for 8 hours.

Copo4 and 1.5% by weight of ILL relative to the total weight of copo4 and of the ionic liquid, are incorporated into the LDPE polyolefin matrix at varied mass contents. Materials in film form are obtained.

The composition of the various materials is given in table 5 below. The values are expressed as mass percentages:

TABLE 5

| Material | H | I | J | K | L | M |
|---|---|---|---|---|---|---|
| LDPE (%) | 90 | 85 | 80 | 90 | 85 | 80 |
| Copo3 + IL1 (%) | 10 | 15 | 20 | — | — | — |
| Copo4 + IL1 (%) | — | — | — | 10 | 15 | 20 |

Material H is a material in which the mass content of copo3 and of IL1 is 10% relative to the weight of material H.

Material I is a material in which the mass content of copo3 and of IL1 is 15% relative to the weight of material I.

Material J is a material in which the mass content of copo3 and of IL1 is 20% relative to the weight of material J.

Material K is a material in which the mass content of copo4 and of IL1 is 10% relative to the weight of material K.

Material L is a material in which the mass content of copo4 and of IL1 is 15% relative to the weight of material L.

Material M is a material in which the mass content of copo4 and of IL1 is 20% relative to the weight of material M.

It should be noted that the assemblies represented by copo3 and ILL and copo4 and ILL are called additives when they are incorporated into the polyolefin matrix.

FIG. 4 is a graph comparing the surface resistance of materials H to M.

It is observed that, for the same mass content of additive, the surface resistance of the material comprising Copo3, doped with ILL is markedly less than that for the material comprising Copo4 doped with ILL

These results prove the better connectivity of the network formed by the copolymer according to the invention incorporated into the polyolefin matrix.

Thus, the results indicate that the copolymer according to the invention makes it possible to improve the antistatic properties of the polymer matrix incorporating same.

1. A copolymer comprising:
from 5 to 50% by weight, relative to the total weight of the copolymer, of at least one polyamide (PA) block,
from 20 to 94% by weight, relative to the total weight of the copolymer, of at least one polyethylene glycol (PEG) block,
from 1 to 45% by weight, relative to the total weight of the copolymer, of at least one block that is more hydrophobic than the PEG block, said block that is more hydrophobic than the PEG block being selected from the group consisting of a polyether (PE) block other than PEG, a polyester (PES) block and a polyolefin (PO) block.

2. The copolymer as claimed in claim 1, wherein the block that is more hydrophobic than the PEG block is selected from the group consisting of:
a PE block selected from the group consisting of polypropylene glycol (PPG), polytetramethylene glycol (PTMG), polyhexamethylene ether glycol, polytrimethylene ether glycol (PO3G), poly(3-alkyl tetrahydrofuran), and copolymers thereof,
a PES block,
a PO block selected from the group consisting of ethylene homopolymers and copolymers, propylene homopolymers and copolymers, styrene/ethylene-butene/styrene (SEBS) block copolymers, styrene/butadiene/styrene (SBS) block copolymers, styrene/isoprene/styrene (SIS) block copolymers, styrene/ethylene-propylene/styrene (SEPS) block copolymers, copolymers of ethylene with at least one product selected from the group consisting of salts or esters of unsaturated carboxylic acids, vinyl esters of saturated carboxylic acids and dienes.

3. The copolymer as claimed in claim 1, wherein said block that is more hydrophobic than the PEG block is a PTMG block.

4. The copolymer as claimed in claim 1, wherein the PA block is selected from the group consisting of PA6, PA11, PA12, PA 4.6, PA 4.12, PA 4.14, PA 4.18, PA 6.6, PA 6.10, PA 6.12, PA 6.14, PA 6.18, PA 9.6, PA 9.12, PA 10.10, PA 10.12, PA 10.14 and PA 10.18 blocks.

5. The copolymer as claimed in claim 1, wherein the arrangement of said copolymer is such that the PA block bonded to a block that is more hydrophobic than the PEG block and to a PEG block is in a central position in the sequence of blocks.

6. The copolymer as claimed in claim 1, wherein the copolymer has a structure selected from the group consisting of PEG-PA6-PTMG, PEG-PA11-PTMG, PEG-PA12-PTMG, PEG-PA10.10-PTMG, PEG-PA10.12-PTMG and mixtures thereof.

7. A process for synthesizing the copolymer as claimed in claim 1, comprising the following steps:
mixing and reacting said PA block with said PEG block and said block that is more hydrophobic than the PEG block, said block that is more hydrophobic than the PEG block being chosen from a polyether (PE) block other than PEG, a polyester (PES) block and a polyolefin (PO) block,
recovering said copolymer.

8. A composition comprising a copolymer as claimed in claim 1.

9. The composition as claimed in claim 8, additionally comprising at least one organic salt.

10. The composition as claimed in claim 8, wherein the composition additionally comprises at least one agent for improving the surface conductivity, selected from the group consisting of: hygroscopic agents, ionic liquids, fatty acids, lubricants, metals, metal films, metal powders, metallic nanopowders, aluminosilicates, amines, esters, fibers, carbon fibers, carbon nanotubes, intrinsically conductive polymers, and mixtures thereof.

11. The composition as claimed in claim 8, wherein the composition additionally comprises at least one additive and/or adjuvant selected from the group consisting of organic and inorganic fillers, reinforcers, plasticizers, stabilizers, antioxidants, UV stabilizers, flame retardants, carbon black, mineral and organic dyes, pigments, dyes, mold-release agents, foaming agents, impact modifiers, shrink-resistance agents, fire retardants, nucleating agents, and mixtures thereof.

12. The composition as claimed in claim 8, additionally comprising a thermoplastic polymer matrix.

13. A method for improving the antistatic properties of a thermoplastic polymer matrix, comprising using a composition in accordance with claim 8.

14. The method as claimed in claim 13, wherein said thermoplastic polymer matrix comprises at least one homopolymeric or copolymeric thermoplastic polymer selected from the group consisting of: polyolefins, polyamides, fluoro polymers, saturated polyesters, polycarbonate, styrene resins, PMMA, thermoplastic polyurethanes (TPU), copolymers of ethylene and of vinyl acetate (EVA), copolymers bearing polyamide blocks and polyether blocks, copolymers bearing polyester blocks and polyether blocks, copolymers bearing polyamide blocks, polyether blocks and polyester blocks, copolymers of ethylene and of an alkyl (meth)acrylate, copolymers of ethylene with vinyl alcohol (EVOH), ABS, SAN, ASA, polyacetal, polyketones, and mixtures thereof.

15. A method for manufacturing at least one object selected from the group consisting of: industrial part, motor vehicle part, safety accessory, sign, cornice lighting, information and advertizing panel, display case, engraving, furnishing, shopfitting, decoration, contact ball, dental prosthesis, ophthalmological implant, blood dialysis membrane, optical fibers, art object, decoration, sculpture, lenses, printing support, glazing, sunroof, and vehicle headlamps, wherein the method comprises using a composition in accordance with claim 8.
